(19) United States
(12) Patent Application Publication
(10) Pub. No.: US 2009/0097596 A1
(43) Pub. Date: Apr. 16, 2009

(54) Methods and Systems for Impulse Noise Compensation for OFDM Systems

(75) Inventors: Junqiang Li, Sunnyvale, CA (US); Baoguo Yang, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/253,026

(22) Filed: Oct. 16, 2008

Related U.S. Application Data
(60) Provisional application No. 60/980,422, filed on Oct. 16, 2007.

(51) Int. Cl. H04L 27/06

(52) U.S. Cl. 375/341

(57) ABSTRACT

Methods and systems are provided to reduce the effects of impulse noise in decoding a received OFDM signal by reducing the bit error number in burst error positions and by reducing the impulse noise contribution to channel estimation. In order to reduce the performance degradation due to impulse noise, it is important to find the position or the OFDM symbol where impulse noise occurs. The high noise variance gain can then be used for a Viterbi decoder to reduce the bit error number in burst error position, and also to reduce the contribution of the channel estimation by impulse noise in future channel estimations. Accordingly, the performance of the system can be greatly improved.

### CROSS REFERENCE

This application claims priority from a provisional patent application entitled “System and Method for Impulse Noise Compensation in DVB-H” filed on Oct. 16, 2007 and having an Application No. 60/980,422. Said application is incorporated herein by reference.

### FIELD OF INVENTION

This invention relates to methods and systems for reducing the effects of impulse noise in the performance of OFDM systems. In particular, this invention relates to methods and systems for reducing the bit error number in burst error position of DVB-H systems.

### BACKGROUND

Orthogonal frequency division multiplexing (“OFDM”) is a multi-carrier transmission technique that uses orthogonal subcarriers to transmit information within an available spectrum. Since the subcarriers may be orthogonal to one another, they may be spaced much more closely together within the available spectrum than, for example, the individual channels in a conventional frequency division multiplexing (“FDM”) system.

In an OFDM system, the subcarriers may be modulated with a low-rate data stream before transmission. It is advantageous to transmit a number of low-rate data streams in parallel instead of a single high-rate stream since low symbol rate schemes suffer less from intersymbol interference (“ISI”) caused by multipath. For this reason, many modern digital communications systems are turning to the OFDM system as a modulation scheme for signals that need to survive in environments having multipath or strong interference. Many transmission standards have already adopted the OFDM system, including the IEEE 802.11a standard, the Digital Video Broadcasting Terrestrial (“DVB-T”), the Digital Video Broadcasting Handheld (“DVB-H”), the Digital Audio Broadcast (“DAB”), and the Digital Television Broadcast (“T-DMB”).

In particular, DVB-H is a technical specification for bringing broadcast services to handheld receivers. DVB-H can offer a downstream channel at high data rates which can stand alone or be used as an enhancement for mobile telecommunications networks which many typical handheld terminals are able to access. The effects of impulse noise are important factors in causing the degradation in performance for a DVB-H system. It can be demonstrated that impulse noise not only generates burst errors, but also introduces burst noise for future channel estimation due to the current channel estimation structure.

Therefore, improved methods and systems for noise compensation are needed to resolve problems caused by impulse noise.

### SUMMARY OF INVENTION

An object of this invention is to provide methods and systems for reducing the bit error number in burst error position for DVB-H systems.

Another object of this invention is to provide methods and systems for reducing the impulse noise contribution to channel estimation.

Briefly, the present invention relates to methods for reducing the effects of impulse noise in decoding a current symbol of a received signal, comprising the steps of: detecting impulse noise position; updating weighed variables for channel estimation as a function of the detected impulse noise position for the current symbol; updating weighed variables for the noise variance of a Viterbi decoder as a function of the detected impulse noise position; and decoding the current symbol.

An advantage of this invention is that the bit error number in burst error position for DVB-H systems is reduced.

Another advantage of this invention is that the impulse noise contribution to channel estimation is reduced.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a fix point design for impulse noise detection.

FIG. 2 is a flow chart that illustrates a process flow for impulse noise compensation.

FIGS. 3(a), 3(b), 3(c), and 3(d) illustrate simulation results for a non-ICI cancellation receiver.

FIGS. 4(a), 4(b), 4(c), and 4(d) illustrate simulation results for an ICI cancellation receiver.

### DETAILED DESCRIPTION OF THE PREFERRED EMBODIMENTS

In order to reduce the performance degradation due to impulse noise, it is important to find the position or the OFDM symbol where impulse noise occurs. The high noise variance gain can then be used for a Viterbi decoder to reduce the bit error number in burst error position, and also to reduce the contribution of the channel estimation by impulse noise in future channel estimations. Accordingly, the performance of the system can be greatly improved.

### Impulse Noise Detection

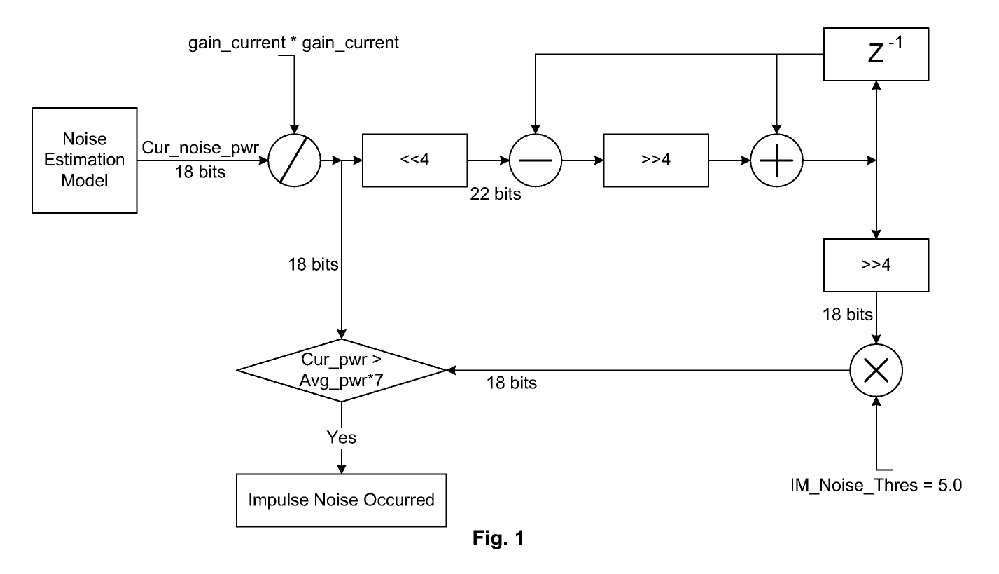

FIG. 1 illustrates a fix point design for impulse noise detection. Referring to Fig. 1, a noise-estimation model is presented for the estimation of noise variance for each symbol and for the calculation of the average noise variance over several symbols (long term average noise variance). If the current noise power is greater than the average noise power multiplied by a threshold, e.g. Cur_pwr>Avg_pwr*threshold, then the position of the noise impulse is identified. The threshold can be a pre-defined number, e.g. 5 or 7, which can be determined from simulation results. This calculation is performed in the frequency domain. Note that the average noise power is calculated over several symbols.

### Impulse Noise Compensation for Both Receivers

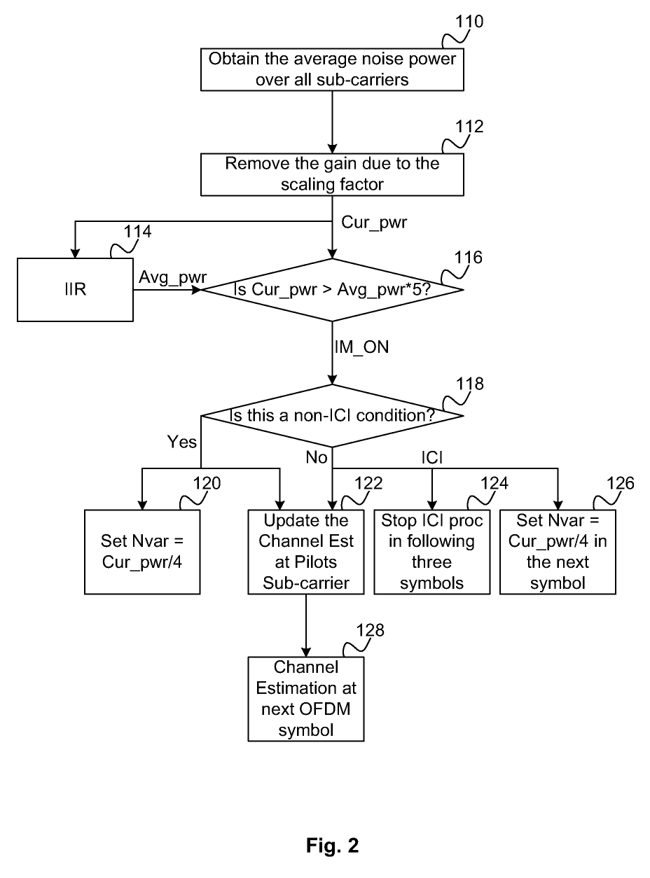

FIG. 2 is a flow chart that illustrates a process flow for impulse noise compensation. Referring to FIG. 2, the average noise power over all sub-carriers is obtained (110). Then, the gain due to scaling factors, e.g. the digital AGC, is removed (112). The IIR filter (114) provides average noise power over several symbols, which is compared against the current power of the current symbol (116). If the current power is greater than the average power times a threshold, e.g. 5, a noise impulse is then identified. If this is a non-ICI condition (118), the noise variance for the Viterbi decoder, Nvar, is set to as a function of the current power, e.g. Cur_pwr/4, (120). If this is an ICI condition, the next few symbols are not ICI processed (124) since ICI processes over several symbols, e.g. 3. The noise variance of the Viterbi decoder is set as a function of the current power, e.g. Cur_pwr/4, over the next few symbols (126).

In the time domain for channel estimation, there may be a number of symbols (n, n−1, . . . , n+1, . . . ), which have weighed variables. If there is a large noise gain, the weighed variables will be reduced for the next symbol to minimize the effect of the large noise gain. In either non-ICI or ICI conditions, the weights of the current symbol for channel estimation are adjusted for the current symbol in the non-ICI case or for the next symbols in the ICI case (122). For example, there are a number of pilots, e.g. continue pilot, scatter pilot, and dedicated data, that are used as weights in performing the channel estimation. They are adjusted accordingly for the current symbol or for the next symbols. After adjustment, channel estimation for the next OFDM symbol can begin (128).

### Channel Estimation Updated at Pilot Positions

At the pilot positions including scatter pilots and continual pilots, the channel estimation value is dominated by the value from the current channel value in time domain interpolation operation. If impulse noise occurs, it is necessary to reduce the noise's contribution to the channel value from the current symbol, which value has an error factor introduced by the impulse noise. For this simulation, NoiseFactorPilot_IM is set to 100. It is demonstrated that the contribution from the current symbol is about 1/50 weaker than from other adjacent dedicated data (“DD”) or pilots. In the current system, previously demodulated data and pilots are used for channel estimation. DD comprises the previously demodulated data.

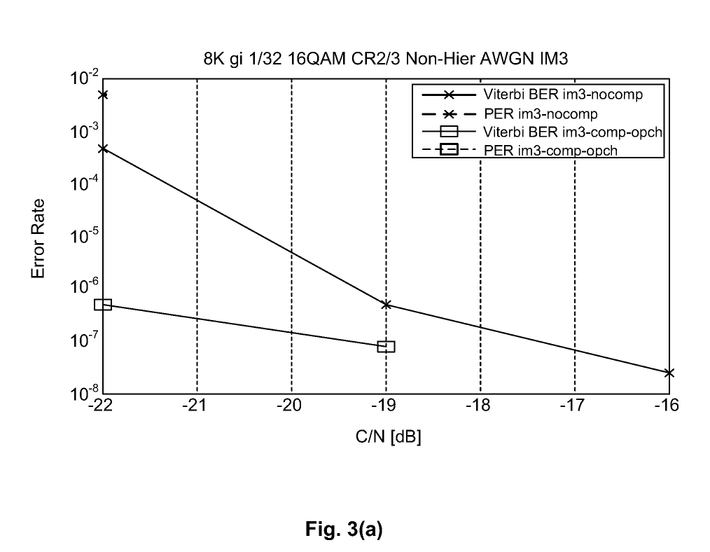

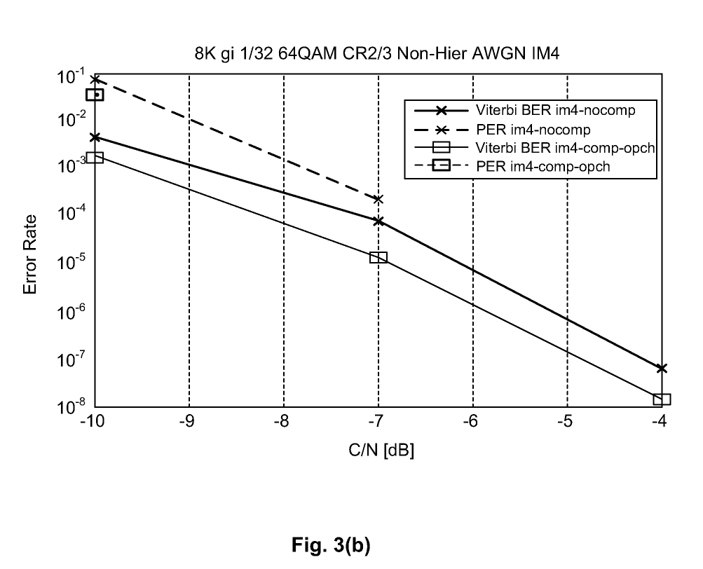

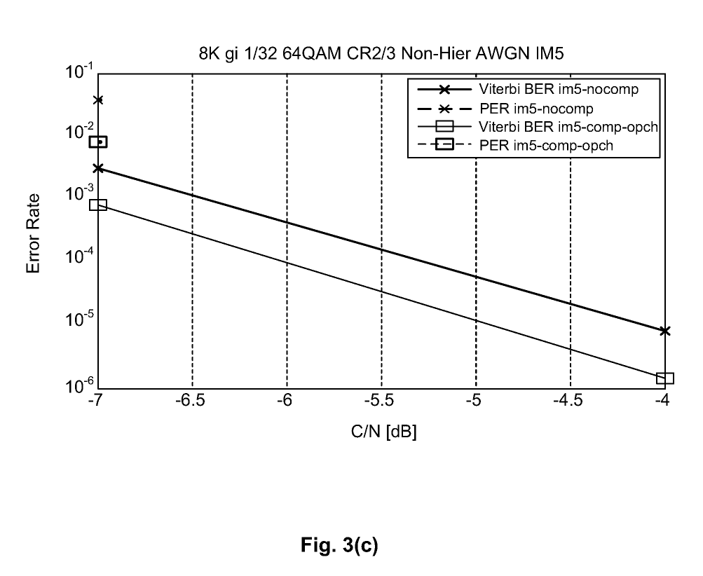

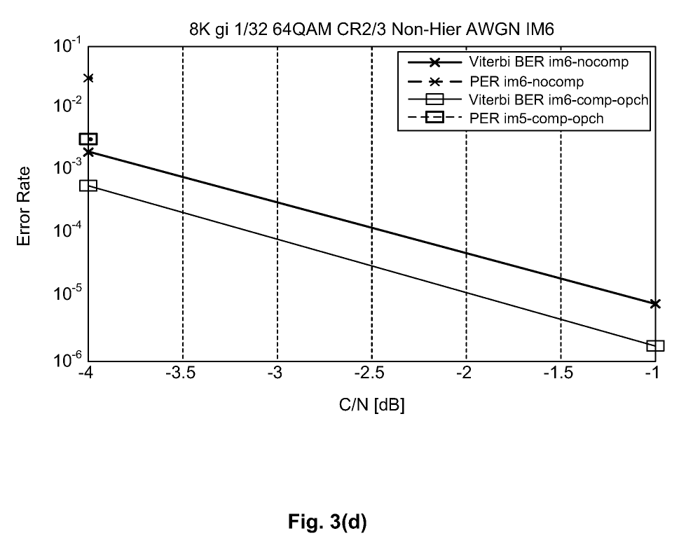

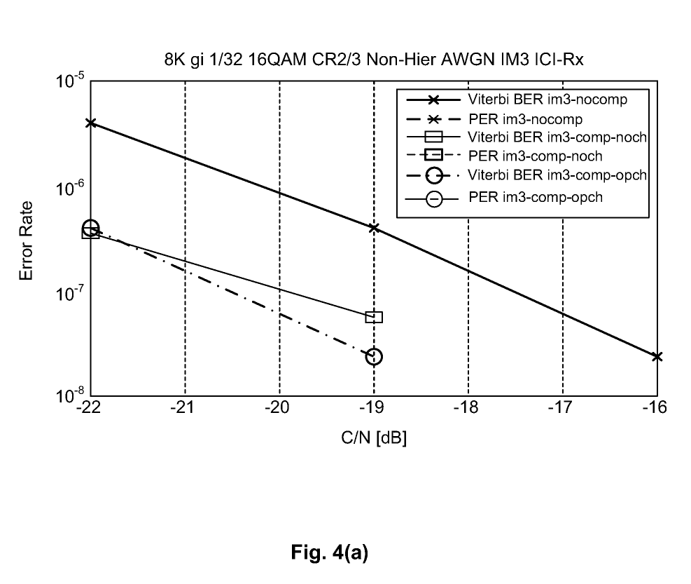

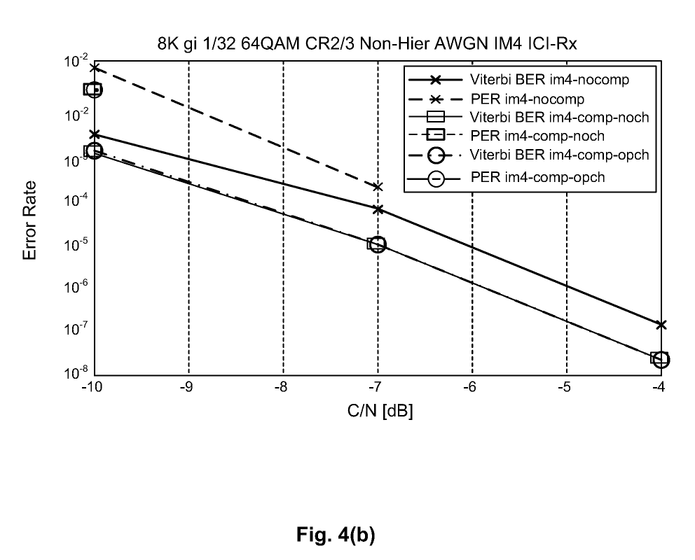

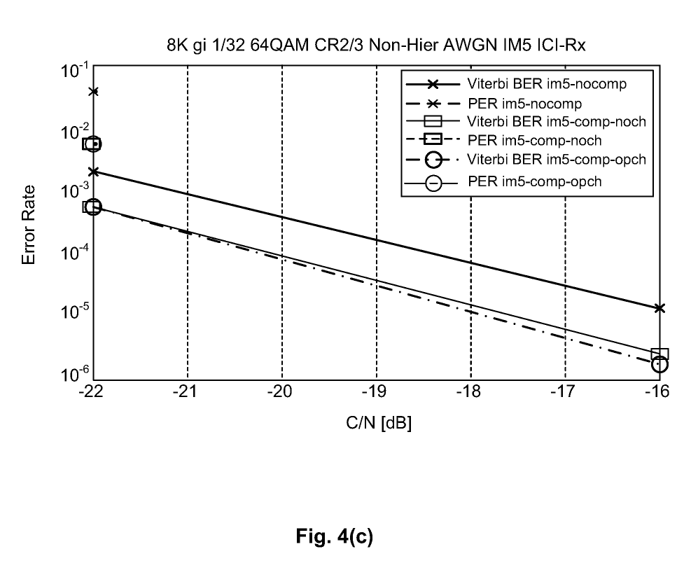

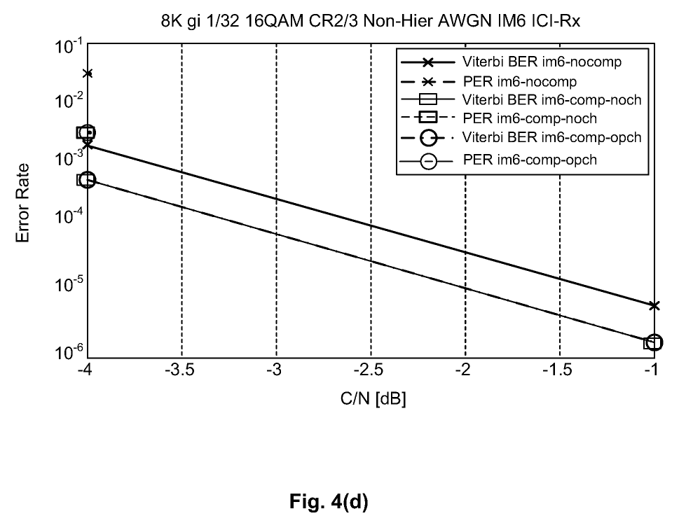

Simulation results are covered in FIGS. 3(a)-3(d) and in FIGS. 4(a)-4(d). The results in FIGS. 4(a)-4(d) are for a non-ICI cancellation receiver; the results in FIGS. 4(a)-4(d) are for an ICI cancellation receiver. FIG. 3(a) illustrates the simulation result of the performance gain for a non-ICI cancellation receiver where impulse noise type 3 of the DVB-H standard is used. FIG. 3(b) illustrates the simulation result of the performance gain for a non-ICI cancellation receiver where impulse noise type 4 of the DVB-H standard is used. FIG. 3(c) illustrates the simulation result of the performance gain for a non-ICI cancellation receiver where impulse noise type 5 of the DVB-H standard is used. FIG. 3(d) illustrates the simulation result of the performance gain for a non-ICI cancellation receiver where impulse noise type 6 of the DVB-H standard is used. FIG. 4(a) illustrates the simulation result of the performance gain for an ICI cancellation receiver where impulse noise type 3 of the DVB-H standard is used. FIG. 4(b) illustrates the simulation result of the performance gain for an ICI cancellation receiver where impulse noise type 4 of the DVB-H standard is used. FIG. 4(c) illustrates the simulation result of the performance gain for an ICI cancellation receiver where impulse noise type 5 of the DVB-H standard is used. FIG. 4(d) illustrates the simulation result of the performance gain for an ICI cancellation receiver where impulse noise type 6 of the DVB-H standard is used.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for reducing the effects of impulse noise in decoding a current symbol of a received signal, comprising the steps of:
detecting an impulse noise position;
updating weighed variables for channel estimation as a function of the detected impulse noise position for the current symbol;
updating weighed variables for the noise variance of a Viterbi decoder as a function of the detected impulse noise position; and
decoding the current symbol.

2. The method of claim 1 wherein for a non-ICI situation, updating weighed variables for the noise variance of the Viterbi decoder as a function of the detected impulse noise position for the current symbol and the noise variance.

3. The method of claim 1 wherein for an ICI situation, updating weighed variables for the noise variance of the Viterbi decoder as a function of the detected impulse noise position for one or more next symbols and the noise variance.

4. The method of claim 3 wherein the ICI situation has a one symbol delay.

5. The method of claim 3 wherein in the ICI situation, the ICI procedure is stopped for the next symbols.

6. The method of claim 1 wherein the detecting the impulse position step comprises the following substeps:
providing a noise estimation model for each symbol;
estimating a long term noise variance; and
if the noise variance of the current symbol is greater than the product of the long term noise variance and a pre-defined threshold, identifying the current symbol as a detected impulse noise position.

7. The method of claim 6 wherein after the providing step, removing scaling effect of a digital AGC from the noise estimation model.

8. The method of claim 2 wherein for an ICI situation, updating weighed variables for the noise variance of the Viterbi decoder as a function of the detected impulse noise position for one or more next symbols and the noise variance.

9. The method of claim 8 wherein the ICI situation has a one symbol delay.

10. The method of claim 8 wherein in the ICI situation, the ICI procedure is stopped for the next symbols.

11. The method of claim 9 wherein the detecting the impulse position step comprises the following substeps:
providing a noise estimation model for each symbol;
estimating a long term noise variance; and
if the noise variance of the current symbol is greater than the product of the long term noise variance and a pre-defined threshold, identifying the current symbol as a detected impulse noise position.

12. The method of claim 11 wherein after the providing step, removing scaling effect of a digital AGC from the noise estimation model.

13. The method of claim 10 wherein the detecting the impulse position step comprises the following substeps:
providing a noise estimation model for each symbol;
estimating a long term noise variance; and
if the noise variance of the current symbol is greater than the product of the long term noise variance and a pre-defined threshold, identifying the current symbol as a detected impulse noise position.

14. The method of claim 13 wherein after the providing step, removing scaling effect of a digital AGC from the noise estimation model.

15. A method for reducing the effects of impulse noise in decoding a current symbol of a received signal, comprising the steps of:
detecting an impulse noise position, comprising the following substeps:
providing a noise estimation model for each symbol;
removing scaling effect of a digital AGC from the noise estimation model;
estimating a long term noise variance; and
if the noise variance of the current symbol is greater than the product of the long term noise variance and a pre-defined threshold, identifying the current symbol as a detected impulse noise position;
updating weighed variables for channel estimation as a function of the detected impulse noise position for the current symbol;
updating weighed variables for the noise variance of a Viterbi decoder as a function of the detected impulse noise position; and
decoding the current symbol.

16. The method of claim 15 wherein for a non-ICI situation, updating weighed variables for the noise variance of the Viterbi decoder as a function of the detected impulse noise position for the current symbol and the noise variance.

17. The method of claim 15 wherein for an ICI situation, updating weighed variables for the noise variance of the Viterbi decoder as a function of the detected impulse noise position for one or more next symbols and the noise variance.

18. The method of claim 17 wherein the ICI situation has a one-symbol delay.

19. The method of claim 17 wherein in the ICI situation, the ICI procedure is stopped for the next symbols.

20. A method for reducing the effects of impulse noise in decoding a current symbol of a received signal, comprising the steps of:
detecting an impulse noise position, comprising the following substeps:
providing a noise estimation model for each symbol;
removing scaling effect of a digital AGC from the noise estimation model;
estimating a long term noise variance; and
if the noise variance of the current symbol is greater than the product of the long term noise variance and a pre-defined threshold, identifying the current symbol as a detected impulse noise position;
updating weighed variables for channel estimation as a function of the detected impulse noise position for the current symbol;
updating weighed variables for the noise variance of a Viterbi decoder as a function of the detected impulse noise position, wherein for a non-ICI situation, updating weighed variables for the noise variance of the Viterbi decoder as a function of the detected impulse noise position for the current symbol and the noise variance, and wherein for an ICI situation, updating weighed variables for the noise variance of the Viterbi decoder as a function of the detected impulse noise position for one or more next symbols and the noise variance, where the ICI situation has a one symbol delay and the ICI procedure is stopped for the next symbols; and
decoding the current symbol.
